(19) United States
(12) Patent Application Publication
(10) Pub. No.: US 2009/0057522 A1
(43) Pub. Date: Mar. 5, 2009

(54) HITCHING POST

(76) Inventor: BRIAN J. BEDELL/FIORE, Austin, TX (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/200,066

(22) Filed: Aug. 28, 2008

Related U.S. Application Data
(60) Provisional application No. 60/966,747, filed on Aug. 29, 2007.

(51) Int. Cl. F16M 13/02

(52) U.S. Cl. 248/544; 29/525.11

(57) ABSTRACT

A hitching post system includes a receiver including a plate sized for spanning spaced apart studs in a wall. The plate includes a plurality of holes to enable anchor bolts to secure the plate to the studs. In addition, the plate includes a tongue receiving hitch and the system includes a fixture having a tongue receivable by the hitch.

This application claims priority from U.S. Provisional Patent Ser. No. 60/966,747 filed Aug. 29, 2008, which is to be incorporated herein in its entirety.

The present invention generally relates to storage systems and is more particularly directed to a wall mounting system for both storage and support of various fixtures for both storage and use.

Typical storage systems, particularly for garage storage, have long been utilized for the storing of various items on the walls or ceilings of a garage.

Garages are often redecorated with extensive shelving to store items off the garage floor but large items, for example, bicycles and ladders and the like are often left on the garage floor.

In addition, many garages do not have work benches and the like and accordingly the support and operation of tools is most difficult.

This is also true for exercise equipment which typically occupies a great deal of floor space and accordingly the use of such equipment in the garage necessitates the parking of an automobile outside of the garage.

The present invention is directed to a system which not only enables the storage of bulky items, but, in addition, provides a mounting system for exercise equipment, storage containers and the like and also work surfaces.

### SUMMARY OF THE INVENTION

Hitching post systems in accordance with the present invention generally include a receiver including a plate sized for spanning spaced apart studs in a wall. The plate includes a plurality of holes therethrough which enable anchor bolts to secure the plate to the studs.

The receiver also includes a tongue receiving hitch and a fixture having a tongue receivable by the hitch. A device is also provided for releasably attaching the fixture to the hitch.

In this manner, any number of fixtures may be removably attached to a wall.

The hitch may extend through the plate to provide greater support for the tongue and the system may include fixtures of various configurations such as a bicycle rack, basket, closeable container, body exercises, or a platform among others.

A method in accordance with the present invention for releasably attaching a fixture to a wall generally includes securing a receiver having a plate and a hitch to a wall with anchor bolts driven into spaced apart wall studs and passing through the plate.

A fixture tongue is inserted into the hitch and releasably attached thereto.

### BRIEF DESCRIPTION OF THE DRAWINGS

The advantages and features of the present invention will be better understood by the following description when considered in conjunction with the accompanying drawings in which:

FIG. 1 is an elevation view of a receiver in accordance with the present invention generally showing holes through a plate for the receipt anchor bolts and a hitch;

FIG. 2 is a cross sectional view taken along the line 2-2 of FIG. 1 generally showing the hitch extending through the receiver plate;

FIG. 3 is a perspective view of the receiver as attached to a spaced apart studs along with a fixture such as a bicycle rack having a tongue for insertion into the hitch and a pin for releasably securing the tongue to the hitch;

FIG. 4 is an illustration of a storage basket having a tongue insertable into the hitch shown in FIGS. 1-3;

FIG. 5 is a view of a closable container including a tongue which is insertable into the hitch of FIGS. 1-3;

FIG. 6 is a view of an exercise fixture having a tongue insertable into the hitch shown in FIGS. 1-3; and

FIG. 7 shows a fixture in the configuration of a platform along with a tongue for insertion into the hitch shown in FIGS. 1-3, the platform being suitable for supporting any preferred tool adjacent the wall.

### DETAILED DESCRIPTION

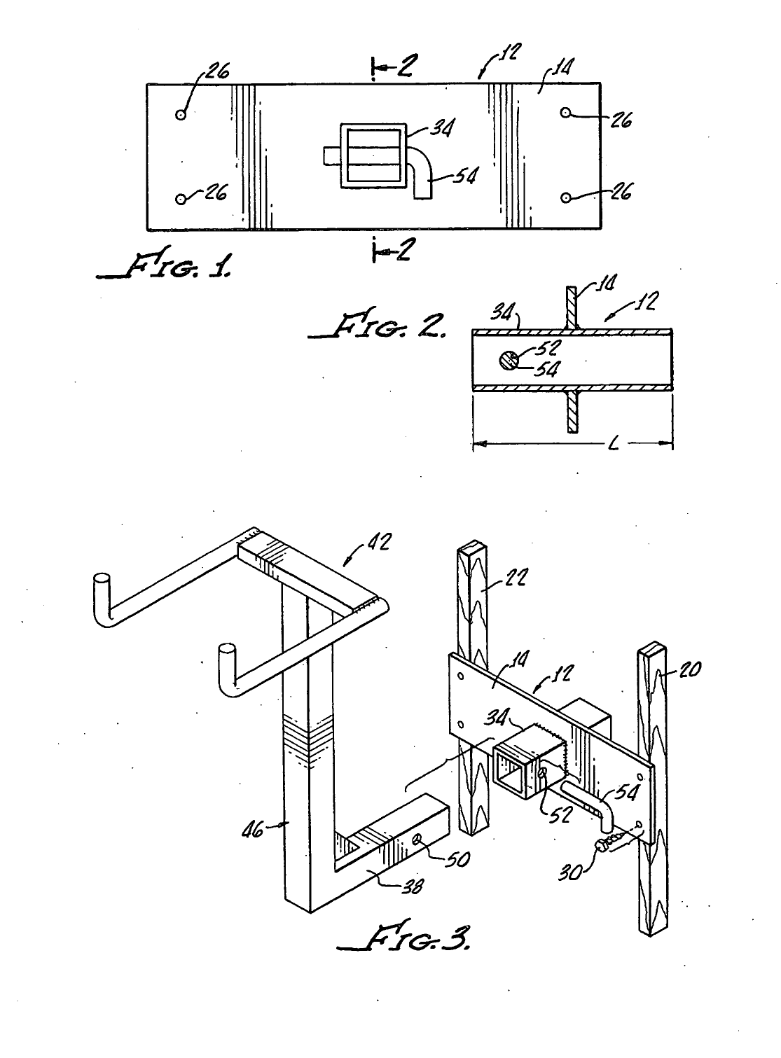

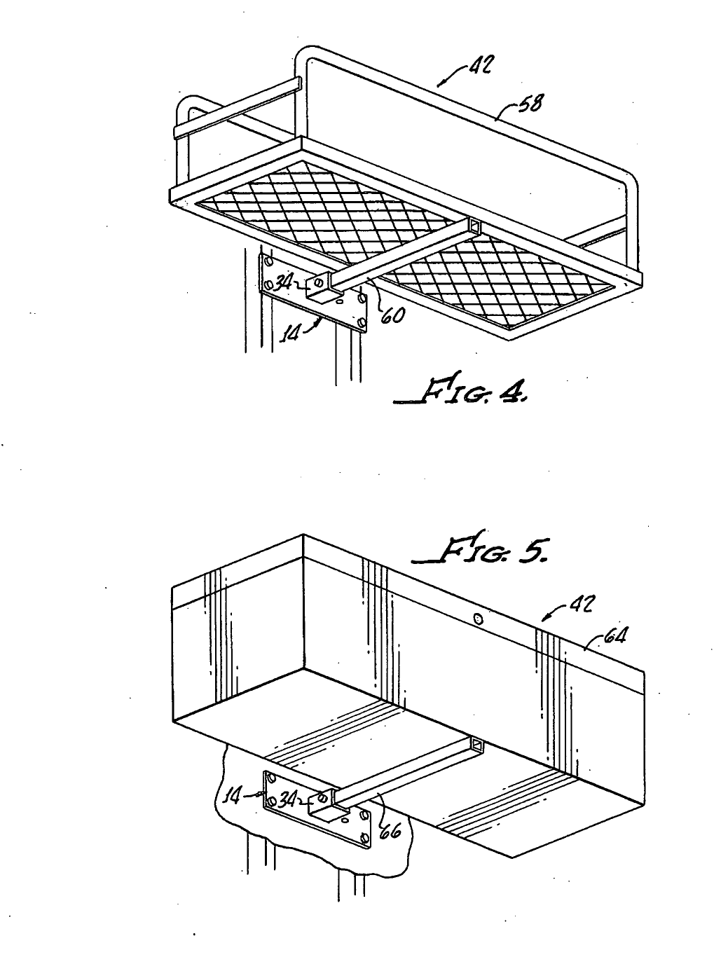

With reference to FIGS. 1 and 2, there is shown a receiver 12 in accordance with the present invention which includes a plate 14 which is sized for spanning spaced apart studs 20, 22, see FIG. 3.

The plate includes a plurality of holes 26 for enabling anchor bolts 30, again see FIG. 3, to secure the plate 14 to the studs 20, 22 which are typically 16 inches apart from one another in conventional construction of walls. The studs 20, 22 may be covered with conventional drywall (not shown) and the plate 14 mounted through the drywall into the studs 20, 22.

The receiver 12 further includes a hitch 34 which may extend through the plate 14 as illustrated in FIG. 2. This provides for greater overall length L for supporting of a tongue 38 as illustrated in FIG. 3.

With further reference to FIG. 3, the receiver 12 is part of a system 42 which further includes a fixture 46. As illustrated in FIG. 3, the fixture 46 is configured for supporting a bicycle (not shown) when the tongue 38 is inserted into the hitch 34. A hole 50 in the tongue 38 and a hole 52 in the hitch 34, when aligned, enable a pin 54 to be inserted through the holes 50, 52 through releasably attached the fixture 46 to the hitch 34. The holes 50, 52 and pin 54 in combination, provide a device for releasably attaching the fixture 46 to the hitch 34.

With reference to FIG. 4, the system 42 may further include a basket 58 attachable to the hitch 34 by a tongue 60, as hereinbefore described in connection with the tongue 38.

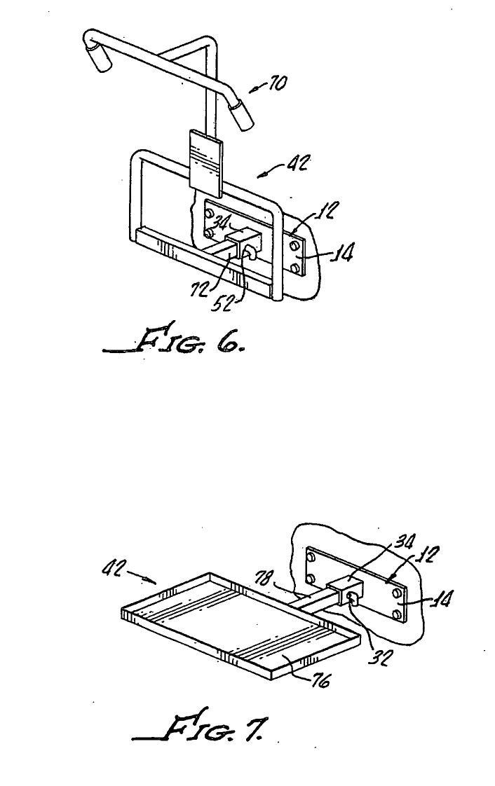

With reference to FIG. 5, the system 42 may further include a closable container 64 attachable to the hitch 34 by a tongue 66 as hereinbefore described.

With reference to FIG. 6, the system 42 may include a body exerciser 70 of any suitable type with a tongue 72 for insertion into the hitch 34.

With reference to FIG. 7, the system 42 may further include a platform fixture may be provided with a tongue 78 for insertion into the hitch 34 as hereinabove described.

It should be appreciated that the system 42 as described herein is not limited to the specific fixtures illustrated.

The system 42 enables a method for releasably attaching a fixture 46, 58, 64, 70, 76 to a wall which includes securing a receiver 12 having a plate 14 and a hitch 34 to the wall with anchor bolts 30 driven through spaced apart wall studs 20, 22, inserting a fixture tongue 38, 60 into the hitch 34 and releasably attaching the tongue 38, 60 to the hitch 34.

Although there has been hereinabove described a specific hitching post in accordance with the present invention for the purpose of illustrating the manner in which the invention may be used to advantage, it should be appreciated that the invention is not limited thereto. That is, the present invention may suitably comprise, consist oft or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A hitching post system comprising:
a receiver including a plate sized for spanning spaced apart studs in a wall, said plate having a plurality of holes therethough for enabling anchor bolts to secure said plate to the studs, said receiver further comprising a tongue receiving hitch;
a fixture having a tongue receivable by the hitch; and
a device for releasable attaching said fixture to the hitch.

2. The system according to claim 1 wherein the hitch extends through said plate.

3. The system according to claim 1 wherein said fixture comprises a bicycle each.

4. The system according to claim 1 wherein said fixture comprises a bracket.

5. The system according to claim 1 wherein said fixture comprises a closeable container.

6. The system according to claim 1 wherein said fixture comprises a body exercise device.

7. The system according to claim 1 wherein said fixture comprises a platform.

8. A hitching post system comprising:
a receiver including a plate sized for spacing spaced apart studs in a wall, said plate having a plurality of holes therethrough for enabling anchor bolts to secure said plate to the studs, said receiver further comprising a tongue receiving hitch;
a plurality of fixtures each having a tongue receivable by the hitch, the plurality of fixtures being selected from a group consisting of bicycle rack, a bracket, a closeable container, a body exerciser, and a platform; and
a device for releasably attaching each of the plurality of fixtures to the hitch.

9. A method for releasably attaching a fixture to a wall, said method comprising:
securing a receiver having a plate on a hitch to the wall with anchor bolts driven into spaced apart wall studs and passing through said plate;
inserting a fixture tongue into said hitch; and
releasably attaching the tongue to said hitch.

10. The method according to claim 9 wherein inserting a fixture tongue comprises inserting a bicycle rack tongue.

11. The method according to claim 9 wherein inserting a fixture tongue comprises inserting a basket tongue.

12. The method according to claim 9 wherein inserting a fixture tongue comprises inserting a closable container tongue.

13. The method according to claim 9 wherein inserting a future tongue comprises inserting a body exerciser tongue.

14. The method according to claim 9 wherein inserting a fixture tongue comprises inserting a platform tongue.

15. The method according to claim 9 wherein inserting a fixture tongue comprises inserting a plurality of future tongue, one at a time, into said hitch.
